(19) United States
(12) Patent Application Publication
(10) Pub. No.: US 2008/0081555 A1
(43) Pub. Date: Apr. 3, 2008

(54) UNIFIED COMMUNICATION REPEATER

(75) Inventors: Sung Ho KONG, Eujeongbu City (KR); Gi Cho KANG, Seoul (KR)

Correspondence Address: WORKMAN NYDEGGER, 60 EAST SOUTH TEMPLE, 1000 EAGLE GATE TOWER, SALT LAKE CITY, UT, 84111, US

(73) Assignee: WIRELESS DATA COMMUNICATION CO., LTD, Seoul (KR)

(21) Appl. No.: 11/538,386

(22) Filed: Oct. 3, 2006

(51) Int. Cl. H04B 7/15

(52) U.S. Cl. 455/11.1

(57) ABSTRACT

A unified communication repeater for wireless communication repeats signals between a network and communication terminals via a wireless line. The unified communication repeater precisely and stably prevents oscillation generation during bidirectional signal repeating, and minimizes radiation patterns serving as signal interference between a receiver antenna and a transmitter antenna for the bidirectional signal repeating.

### BACKGROUND OF THE INVENTION

1. Field of the Invention

The present invention relates to wireless communication, and more particularly, to a unified communication repeater for repeating signals between a network and a communication terminal via a wireless line.

2. Discussion of the Related Art

Due to development of communication technology, a variety of wireless communication services are provided via a wireless line.

Recently, as the number of wireless communication service subscribers is increased, the number of stations is remarkably increased to provide sufficient wireless communication service.

However, since circumstance of the wireless communication service is too unstable, a shadow area where radio waves cannot arrive still exists

Success of wireless communication provider is dependent upon whether the shadow area is effectively removed with low costs or not.

Meanwhile, the most effective method of removing the shadow area is to use a repeater to repeat signals between a network and users.

Existing service providers install various kinds of repeaters in areas determined as the shadow areas to maximize the wireless service.

However, due to the increase of the repeaters, reversely entering noise is also increased, and oscillation is generated according to the installation place or the installation circumstance of the repeaters.

Particularly, since the oscillation is applied to the signals as noise, load is increased and the quality of the signals is deteriorated.

Thus, a solution is needed to detect the oscillation and to effectively remove and interrupt the oscillation.

On the other hand, a conventional repeater includes a receiver antenna (donor antenna) and a transmitter antenna (coverage antenna).

Such an antenna includes a radiator for radiating and absorbing radio waves and a reflector for reflecting the radio waves.

The reflector is attached to a rear side of the radiator, to reflect the radio waves radiated from the radiator, or to reflect the absorbed radio waves.

Each antenna of the conventional repeater which has the above-mentioned configuration, exhibits radiation patterns having front-to-back ratio (FTBR) characteristics and front-to-side ratio (FTSR) characteristics, due to scattering waves occurring at the edges of the reflectors of the antenna. The radiation patterns having FTBR characteristics are back-lobes, whereas the radiation patterns having FTSR characteristics are side-lobes.

For this reason, the receiver antenna and transmitter antenna of the conventional repeater radiate a large amount of waves in lateral directions and in a back direction. As a result, signal interference occurs between the receiver antenna and the transmitter antenna.

In order to suppress such signal interference occurring between the receiver antenna and the transmitter antenna, a sufficient isolability must be secured between the two antennas. For this reason, there is a difficulty in installing the antennas.

### SUMMARY OF THE INVENTION

Accordingly, present invention is directed to a unified communication repeater that substantially obviates one or more problems due to limitations and disadvantages of the related art.

An object of the present invention is to provide a unified communication repeater for precisely and stably preventing oscillation generated during the bidirectional repeating of signals.

Another object of the present invention is to provide a unified communication repeater for minimizing radiation patterns serving as signal interference between a receiver antenna and a transmitter antenna for the bidirectional signal repeating.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a unified communication repeater for repeating a downlink signal and an uplink signal between a network and a terminal, including: a repeater circuit for adjusting an attenuation value for one of a removal of oscillation from and a maintenance of oscillation margin in signals that are received from one of the network and the terminal, during the repeating the downlink signal and the uplink signal; a housing for protecting the repeater circuit; a first antenna formed at a side of the housing to receive the downlink signal from the network and to transmit the uplink signal transmitted from the repeater circuit to the network; and a second antenna formed at the opposite side of the housing to receive the uplink signal from the terminal and to transmit the downlink signal transmitted from the repeater circuit to the terminal.

Preferably, the first antenna includes a first radiator electrically connected to the repeater circuit to receive the downlink signal from the network and to transmit the uplink signal to the network, and a first reflector including a first side wall and a second side wall having a dual-layer structure and being obliquely extended from a side of the housing to surround the first radiator.

Preferably, the second antenna includes a second radiator electrically connected to the repeater circuit to receive the uplink signal from the terminal and to transmit the downlink signal to the terminal, and a second reflector including a third side wall and a fourth side wall having a dual-layer structure and being obliquely extended from the other side of the housing to surround the second radiator.

In the above-description, the first side wall and the second side wall being spaced apart from each other by a predetermined distance and being obliquely extended with respect to a side of the housing at an acute angle, and the third side wall and the fourth side wall being spaced apart from each other by a predetermined distance and being obliquely extended with respect to the side of the housing at an acute angle. In detail, the lengths of the side walls extended from a side of the housing may be λ/4, or the lengths of the side walls extended from the side of the housing may be λ/4±λ/8. Moreover, a gap between the side walls may be λ/4. The side walls may be obliquely extended with respect to the side of the housing.

Preferably, the repeater circuit includes a mixer for performing frequency conversion, a filter for filtering an output from the mixer at a predetermined frequency broadband, a detector for detecting oscillation from an output from the filter, and a controller for adjusting the attenuation value for one of the removal of the oscillation from the signal inputted into the mixer and the maintenance of the oscillation margin according to whether the oscillation is detected by the detector. The controller adjusts the attenuation value up when the oscillation is detected. Moreover, the detector sweeps a local oscillation frequency provided to the mixer for the frequency conversion, and the controller estimates levels according to respective frequency broadbands, extracted in correspondence with the local oscillation frequency, and determines that the oscillation occurs at a corresponding frequency when the estimated level is equal to or greater than a predetermined level. In this case, the controller estimates the levels according to the respective frequency broadbands extracted in correspondence with the local oscillation frequency and variation of the levels of at least one of the frequency broadbands when no oscillation occurs, adjusts the attenuation value up when the estimated variation is equal to or greater than a predetermined level, and adjusts the attenuation value down when the estimated variation is less than the predetermined level. Moreover, an adjusting range of the attenuation value when no oscillation occurs is set to be less than an adjusting range of the attenuation value when the oscillation is detected. The variation is a distribution of the levels according to plural frequency broadbands extracted in correspondence to the local oscillation frequency.

Preferably, the first antenna and the second antenna are formed at different sides of the housing.

Preferably, the first antenna and the second antenna are formed at a side and an opposite side of the housing.

To achieve other objects and other advantages and in accordance with the purpose of the invention, as embodied and broadly described herein, a unified communication repeater for repeating a signal between a network and a terminal, includes: an antenna comprising a first antenna device including a first radiator and a first reflector to transmit and receive signals to and from the network, and a second antenna device including a second radiator and a second reflector to transmit and receive signals to and from the terminal; a repeater circuit for performing amplifying of, conversion of frequencies of, and removal of oscillation from signals received from the network and the terminal; and a housing for shielding the repeater circuit to protect the repeater circuit.

Preferably, the repeater circuit estimates signal levels according respective frequencies using a result of broadband pass filtering of a received signal from one of the network and the terminal, detects the oscillation at a specific frequency broadband from the estimating result, and adjusts an attenuation value with respect to a corresponding frequency broadband where the oscillation occurs so that the oscillation is removed. Particularly, the repeater circuit estimates a distribution with respect to the signal levels of the estimated frequency broadbands when the oscillation is not detected from the estimated result, adjusts the attenuation value up when the distribution is equal to or greater than a predetermined level, and adjusts the attenuation value down when the distribution is less than the predetermined level.

Preferably, the first antenna device is formed at a side of the housing and the second antenna device is formed at the side opposite to the side where the first antenna device is formed so that a signal transmitting and receiving direction of the first antenna device is opposite to that of the second antenna device.

Preferably, the reflectors are attached to different sides of the housing, and each of the reflectors includes bottom walls attached to a corresponding side of the housing and side walls obliquely extended from the bottom walls. Here, a distance between the side walls is less than a length in a direction where the side walls are respectively extended from the bottom walls. A distance between the side walls is less than λ/4. The lengths of the side walls in the direction where the side walls are extended from the bottom walls may be λ/4. The lengths of the side walls in the direction where the side walls are extended from the bottom walls may be λ/4±λ/8. The side walls are obliquely extended from the bottom walls at an acute angle.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a configuration of a unified communication repeater according to the present invention;

FIGS. 2a and 2b are respectively a sectional view and a partial detail view illustrating a communication repeater according to a first embodiment of the present invention;

FIG. 3 is a view illustrating configuration of a communication repeater according to a second embodiment of the present invention;

FIG. 4 is a block diagram illustrating configuration of a repeater circuit for removing oscillation and for maintaining oscillation margin in the communication repeater according to the present invention; and

FIG. 5 is a flowchart illustrating process of removing oscillation and maintaining oscillation margin in the communication repeater according to the present invention.

### DETAILED DESCRIPTION OF THE INVENTION

Reference will now be made in detail to the preferred embodiments of a unified communication repeater, examples of which are illustrated in the accompanying drawings.

Hereinafter, configuration and operation of embodiments of the present invention will be described with reference to the accompanying drawings. The configuration and operation of the present invention, illustrated in the drawings and described with reference to the drawings, will be described by at least one embodiment, but the description is not intended to limit the technical spirit and essential configuration and operation of the present invention.

Hereinafter, a unified communication repeater according to the embodiments of the present invention will be described with reference to the accompanying drawing.

The unified communication repeater according to the embodiment of the present invention repeats signals between a network to provide communication service and terminals to receive the communication service. In other words, the unified communication repeater repeats a signal (hereinafter referred to as a ‘downlink signal’) from the network to the terminals and a signal (hereinafter referred to as an ‘uplink signal’) from the terminals to the network.

Particularly, the unified communication repeater has an antenna for minimizing signal interference that would be generated during the repeating of the downlink signal and the uplink signal.

Moreover, the unified communication repeater according to the embodiment of the present invention includes a device for detecting minute oscillation from the signals repeated bidirectionally and for preventing the signals from oscillating.

The antenna of the present invention minimizes lobes serving as interference between signals, particularly, minimizes back-lobes, that is, radiation patterns having Front-to-Back Ratio (FTBR) characteristics.

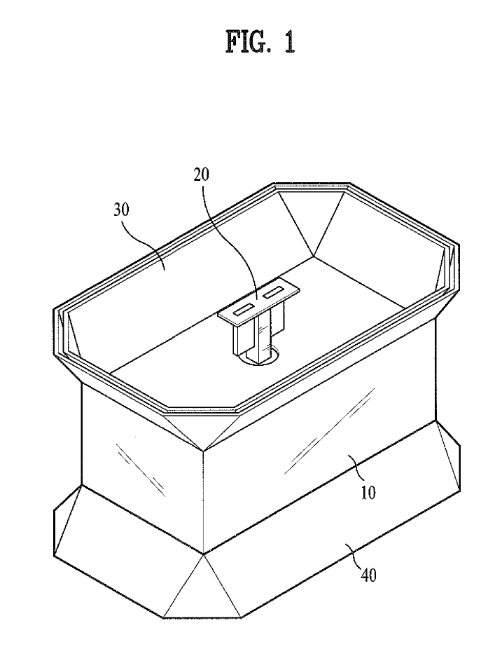

FIGS. 1 to 3 are views illustrating a configuration of a unified communication repeater of the present invention to minimize lobes, particularly, the back-lobes.

FIG. 1 is a view illustrating the configuration of the unified communication repeater according to the present invention.

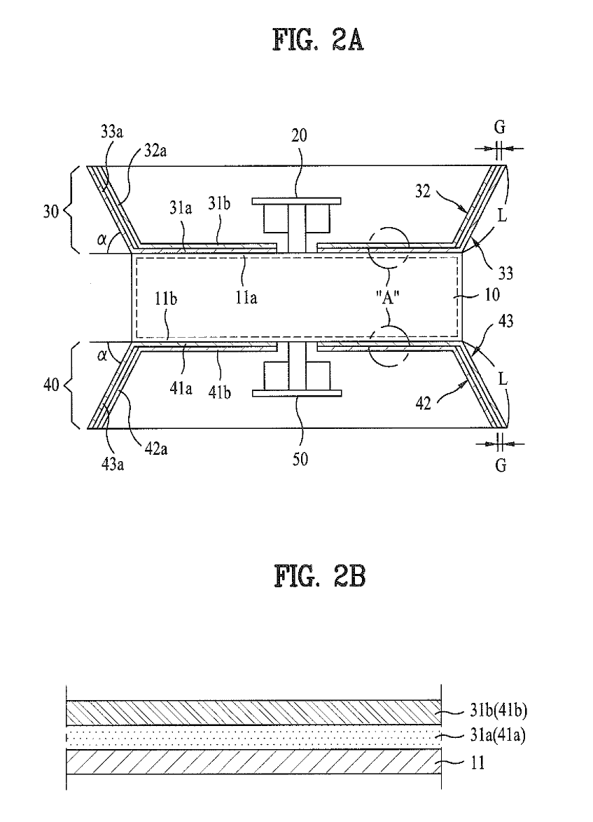

FIGS. 2a and 2b are respectively a sectional view and a partial detail view illustrating a communication repeater according to a first embodiment of the present invention, namely, detail views of the repeater in FIG. 1.

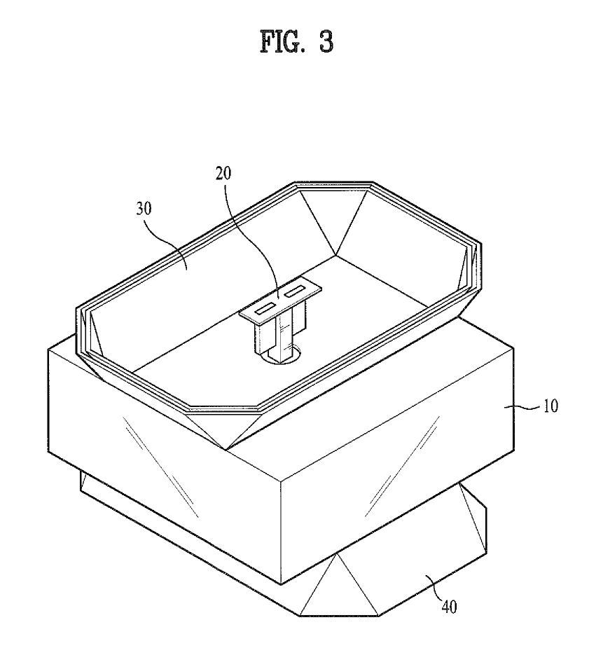

FIG. 3 is a view illustrating configuration of a communication repeater according to a second embodiment of the present invention.

The unified communication repeaters in FIGS. 1 to 3 include repeater circuits installed to repeat the downlink signals and the uplink signals between the network and the terminals.

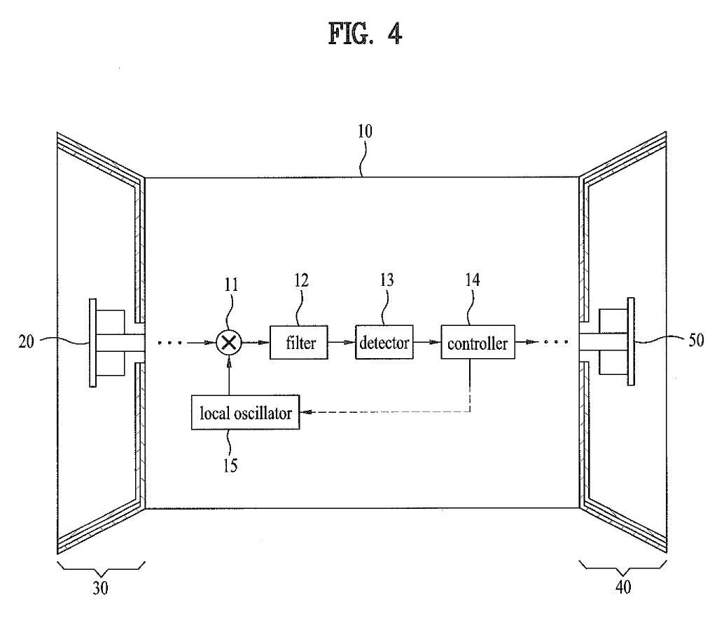

Configuration of the repeater circuit is illustrated in FIG. 4, and the unified communication repeater of the present invention includes a housing 10 for protecting the repeater circuit.

The housing 10 shields the repeater circuit. The housing 10 is electrically grounded.

Antennas for the bidirectional transmission and reception of signals are attached to opposite sides of the housing 10.

The antennas are distinguished as a first antenna for transmitting and receiving signals between the unified communication repeater and the network and a second antenna for transmitting and receiving signals between the unified communication repeater and the terminals.

The first antenna and the second antenna are attached to the opposite sides of the housing 10, preferably, disposed on the opposite sides 11a and 11b of the housing 10 to face one's back toward the other's back.

In more detail, the first antenna is attached to a side of the housing 10 to receive the downlink signal from the network. Moreover, the first antenna transmits the uplink signal transmitted from the repeater circuit to the network.

The second antenna, opposite to the direction where the first antenna is attached, is attached to the other side of the housing 10 to receive the uplink signal from the terminal. Moreover, the second antenna transmits the downlink signal transmitted from the repeater circuit to the terminal.

In the unified communication repeater of the present invention, the respective antennas include radiators 20 and 50 and reflectors 30 and 40, and hereinafter, the reflectors will be described.

The reflectors 30 and 40 include bottom walls 31a, 31b, 41a, and 41b attached to an entire portion or a part of a side of the housing 10, and side walls 32 and 33, 32a and 33a, 42 and 43, and 42a and 43a obliquely extended from the sides of the bottom walls 31a, 31b, 41a, and 41b.

FIG. 3 illustrates an example of the reflectors attached to a part of a side of the housing.

The side walls have a dual structure having a predetermined gap G, and preferably, the directions of the side walls extended from the sides of the bottom walls are the wave radiation directions such that the reflector 20 is surrounded.

For example, the reflectors 30 and 40, for the easy manufacturing, have a configuration in which two reflector assemblies having bottom widths different from each other are accumulated as shown in FIG. 2a.

As the two reflector assemblies with different bottom widths are accumulated, the side walls 32 and 33, 32a and 33a, 42 and 43, and 42a and 43a are spaced apart from each other by the predetermined gap G.

Hereinafter, the accumulated reflector will be described.

However, the configuration of the reflector of the present invention is not limited to a dual-layer structure, namely, the structure in which two reflectors are accumulated.

Since the reflectors in FIG. 2a have an identical structure, only one of the reflectors will be described, and it will be apparent that the detailed description of the reflector can be applied to the other.

The reflector 30 is made of an electrical conductor.

The bottom walls 31a and 31b of the reflector 30 have holes formed at the central points thereof The radiator 20 is formed at the central potions of the holes. The radiator 20 is spaced apart from the outer sides of the holes by a predetermined distance so that the radiator 20 is formed.

When the reflector 20 is configured as shown in FIG. 2a, the gap G between the side walls is shorter than a length L extended from the sides of the bottom walls. Here, a length of the outer side walls 33 and 33a formed at the outer side of the reflector is provided as an example of the length L.

As another example, the gap G between the side walls may be shorter than a length of the inner side walls 32 and 32a formed inside the reflector. Here, the lengths of the inner side walls formed inside the reflector 30 are shorter than lengths of the outer side walls formed outside the reflector 30. A difference between the lengths of the side walls is changed according to thicknesses of the reflector and gaps between the side walls. For example, the gap between two side walls is less than λ/4.

The lengths of the side walls, namely, the lengths L of the outer side walls extended from the side of the bottom walls of the reflector and the lengths of the inner side walls are greater than the gap G between the two side walls. For example, the lengths L of the outer side walls of the reflector may be λ/4. Moreover, for another example, the lengths L of the side walls of the reflector may be λ/4±λ/8.

The side walls are obliquely extended at an acute angle α with respect to the side to which the reflector is attached. This means that the side walls and the bottom walls form the acute angle α, and preferably, the acute angle α is 45 degrees.

Next, the oscillation removal and the oscillation maintenance performed by the unified communication repeater according to the present invention will be described in detail.

FIG. 4 is a block diagram illustrating configuration of a repeater circuit for removing oscillation and for maintaining oscillation margin in the communication repeater according to the present invention.

Referring to FIG. 4, the unified communication repeater includes a repeater circuit for repeating the downlink signal and the uplink signal between the network and the terminal, and the repeater circuit is electrically connected to the radiators provided in the bidirectional antennas.

The repeater circuit performs basic signal processing required in the signal repeating such as frequency conversion and amplifying of the signals.

During the repeating of the downlink signal from the network to the terminal or of the uplink signal from the terminal to the network, the repeater circuit removes the oscillation from the signal received from one of the network and the terminal. Moreover, the repeater circuit adjusts an attenuation value to maintain the oscillation margin of the received signals.

An adjusting range of the attenuation value for the removal of the oscillation is a large value relative to an adjusting range of the attenuation value for the maintenance of the oscillation margin. Thus, the adjusting range for the maintenance of the oscillation margin is set to be less than the adjusting range for the removal of the oscillation. For example, the adjusting range for the removal of the oscillation is set to 3 dB, and the adjusting range for the maintenance of the oscillation margin is set to ±1 dB.

As shown in FIG. 4, the repeater circuit for removing the oscillation and maintaining the oscillation margin includes a mixer 11, a filter 12, a detector 13, a controller 14, and a local oscillator 15.

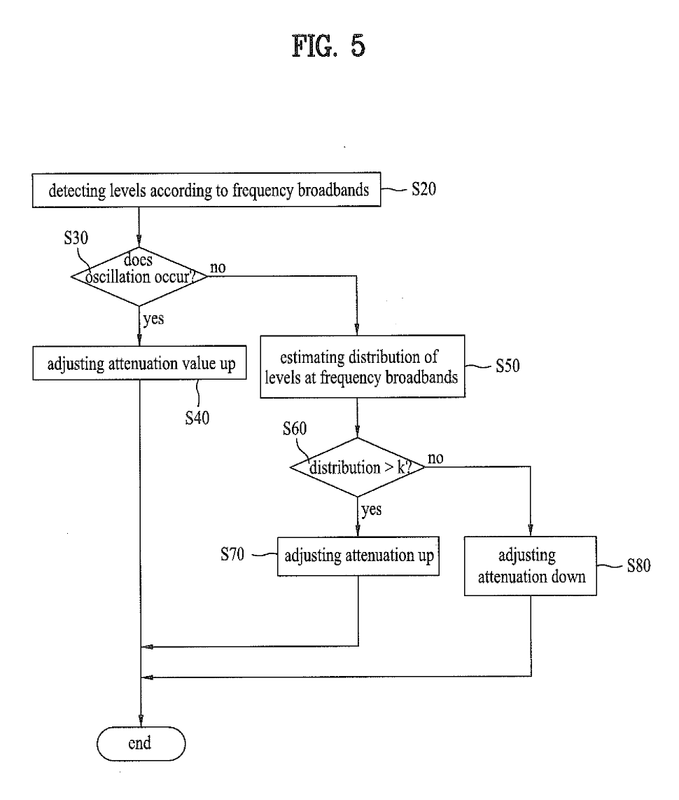

FIG. 5 is a flowchart illustrating a process of removing oscillation and maintaining oscillation margin in the communication repeater according to the present invention and operations performed by the components in FIG. 4.

The mixer 11 converts frequency of the signal inputted into the repeater circuit. For example, the mixer 11 mixes a signal of high frequency with a signal of a predetermined frequency inputted from the local oscillator 15 to convert the signal of high frequency into a signal having a frequency lower than the frequency of the signal when the signal is inputted, or vice versa.

The filter 12 filters the output from the mixer 11 at a predetermined frequency broadband. In this case, the frequency broadband to be filtered is determined according to a filtering coefficient of the filter 12.

The detector 13 monitors a signal outputted from the filter 12 to detect whether there is oscillation. The detector 13 sweeps a local oscillation frequency provided from the local oscillator 15 to the mixer 11 for the purpose of frequency conversion. In this case, the detector 13 controls a phase locked loop (PLL) to sweep the local oscillation frequency. After that, the detector 13 detects levels according to respective frequency broadbands extracted in correspondence with the local oscillation frequency (S20).

The detected levels are converted into the unit of dBm.

The controller 14 estimates the dBm values of the levels according to the frequency broadbands detected by the detector 13. After that, the controller 14 compares the estimated levels with a predetermined critical value to determine whether there is oscillation (S30).

According to whether the oscillation is generated or not, the controller 14 performs control for removing the oscillation from the signal inputted into the mixer 11 or for maintaining the oscillation margin.

If the level of the detected frequency broadband is equal to or greater than the critical value, the controller 14 determines that the oscillation occurs and adjusts the attenuation value up by a predetermined attenuation adjusting range for the removal of the oscillation (S40). For example, as described above, the attenuation adjusting range is set to 3 dB. Moreover, for example, the mixer 11 may be provided in the front side thereof with an attenuator whose attenuation value is adjusted by the controller 14.

On the other hand, if the level of the detected frequency broadband is less than the critical value, the controller determines that the oscillation does not occur.

When it is determined no oscillation occurs, the controller 14 further determines whether the level of the detected frequency broadband is as high as the attenuation value adjusting range for the maintenance of the oscillation margin.

In other words, the controller 14 estimates the levels of the frequency broadbands extracted in correspondence with the local oscillation frequency and variation of the levels with respect to at least one of the frequency broadbands (S50). Here, the variation is a distribution of the estimated levels.

After that, the controller 14 compares the estimated variation with a reference value K required to maintain the oscillation margin (S60). For this reason, when the estimated variation is equal to or greater than a predetermined value, the controller 14 adjusts the attenuation value up by the predetermined attenuation adjusting range (S70). On the other hand, when the estimated variation is not equal to nor greater than the predetermined value, the controller 14 adjusts the attenuation value down by the predetermined attenuation adjusting range (S80). The attenuation adjusting range for the maintenance of the oscillation margin having different absolute values may be used according to when the estimated variation is equal to or greater than the predetermined value or not. In the present invention, the attenuation adjusting range is set to 1 dB when the estimated variation is equal to or greater than the predetermined value and is set to − (negative) dB vice versa.

Even when the oscillation does not occur as described above, the attenuation value is adjusted in advance for the maintenance of the oscillation margin so that the possibility of generating the oscillation in the future can be minimized.

In other words, in the present invention, even when there is no oscillation, the attenuation value is adjusted to a level where the oscillation occurs.

As described above, the unified communication repeater of the present invention minimizes the radiation patterns having front-to-back ratio (FTBR) characteristics and front-to-side ratio (FTSR) characteristics, due to scattering waves occurring at the edges of the reflectors of the respective antennas. As a result, a sufficient isolability is sufficiently secured between the receiver antenna and the transmitter antenna and the interference between the antennas is minimized.

Moreover, since it is free from the signal interference between the antennas, the antennas are easily arranged in the unified communication repeater for the bidirectional transmission and reception of signals.

Additionally, the unified communication repeater of the present invention removes the oscillation and maintains the oscillation margin to prevent the oscillation being generated in the future.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A unified communication repeater for repeating a downlink signal and an uplink signal between a network and a terminal, comprising:
a repeater circuit for adjusting an attenuation value for one of a removal of oscillation from and a maintenance of oscillation margin in signals that are received from one of the network and the terminal, during the repeating the downlink signal and the uplink signal;
a housing for protecting the repeater circuit;
a first antenna formed at a side of the housing to receive the downlink signal from the network and to transmit the uplink signal transmitted from the repeater circuit to the network; and
a second antenna formed at the opposite side of the housing to receive the uplink signal from the terminal and to transmit the downlink signal transmitted from the repeater circuit to the terminal.

2. The unified communication repeater according to claim 1, wherein the first antenna comprises:
a first radiator electrically connected to the repeater circuit to receive the downlink signal from the network and to transmit the uplink signal to the network; and
a first reflector including a first side wall and a second side wall having a dual-layer structure and being obliquely extended from a side of the housing to surround the first radiator, the first side wall and the second side wall being spaced apart from each other by a predetermined distance and being obliquely extended with respect to a side of the housing at an acute angle.

3. The unified communication repeater according to claim 1, wherein the second antenna comprises:
a second radiator electrically connected to the repeater circuit to receive the uplink signal from the terminal and to transmit the downlink signal to the terminal; and
a second reflector including a third side wall and a fourth side wall having a dual-layer structure and being obliquely extended from the other side of the housing to surround the second radiator, the third side wall and the fourth side wall being spaced apart from each other by a predetermined distance and being obliquely extended with respect to the side of the housing at an acute angle.

4. The unified communication repeater according to claim 1, wherein the repeater circuit comprises:
a mixer for performing frequency conversion;
a filter for filtering an output from the mixer at a predetermined frequency broadband;
a detector for detecting oscillation from an output from the filter; and
a controller for adjusting the attenuation value for one of the removal of the oscillation from the signal inputted into the mixer and the maintenance of the oscillation margin according to whether the oscillation is detected by the detector.

5. The unified communication repeater according to claim 4, wherein the controller adjusts the attenuation value up when the oscillation is detected.

6. The unified communication repeater according to claim 4, wherein the detector sweeps a local oscillation frequency provided to the mixer for the frequency conversion, and the controller estimates levels according to respective frequency broadbands, extracted in correspondence with the local oscillation frequency, and determines that the oscillation occurs at a corresponding frequency when the estimated level is equal to or greater than a predetermined level.

7. The unified communication repeater according to claim 6, wherein the controller estimates the levels according to the respective frequency broadbands extracted in correspondence with the local oscillation frequency and variation of the levels of at least one of the frequency broadbands when no oscillation occurs, adjusts the attenuation value up when the estimated variation is equal to or greater than a predetermined level, and adjusts the attenuation value down when the estimated variation is less than the predetermined level.

8. The unified communication repeater according to claim 7, wherein, an adjusting range of the attenuation value when no oscillation occurs is set to be less than an adjusting range of the attenuation value when the oscillation is detected.

9. The unified communication repeater according to claim 7, wherein the variation comprises a distribution of the levels according to plural frequency broadbands extracted in correspondence to the local oscillation frequency.

10. The unified communication repeater according to claim 1, wherein the first antenna and the second antenna are formed at different sides of the housing.

11. The unified communication repeater according to claim 1, wherein the first antenna and the second antenna are formed at a side and an opposite side of the housing.

12. A unified communication repeater for repeating a signal between a network and a terminal, comprising:
an antenna comprising a first antenna device including a first radiator and a first reflector to transmit and receive signals to and from the network, and a second antenna device including a second radiator and a second reflector to transmit and receive signals to and from the terminal;
a repeater circuit for performing amplifying of, conversion of frequencies of, and removal of oscillation from signals received from the network and the terminal; and
a housing for shielding the repeater circuit to protect the repeater circuit.

13. The unified communication repeater according to claim 12, wherein the repeater circuit estimates signal levels according respective frequencies using a result of broadband pass filtering of a received signal from one of the network and the terminal, detects the oscillation at a specific frequency broadband from the estimating result, and adjusts an attenuation value with respect to a corresponding frequency broadband where the oscillation occurs so that the oscillation is removed.

14. The unified communication repeater according to claim 13, wherein the repeater circuit estimates a distribution with respect to the signal levels of the estimated frequency broadbands when the oscillation is not detected from the estimated result, adjusts the attenuation value up when the distribution is equal to or greater than a predetermined level, and adjusts the attenuation value down when the distribution is less than the predetermined level.

15. The unified communication repeater according to claim 12, wherein the first antenna device is formed at a side of the housing and the second antenna device is formed at the side opposite to the side where the first antenna device is formed so that a signal transmitting and receiving direction of the first antenna device is opposite to that of the second antenna device.

16. The unified communication repeater according to claim 12, wherein the reflectors are attached to different sides of the housing, and each of the reflectors includes bottom walls attached to a corresponding side of the housing and side walls obliquely extended from the bottom walls.

17. The unified communication repeater according to claim 16, wherein a distance between the side walls is less than a length in a direction where the side walls are respectively extended from the bottom walls.

18. The unified communication repeater according to claim 17, wherein a distance between the side walls is less than λ/4.

19. The unified communication repeater according to claim 17, wherein the side walls are obliquely extended from the bottom walls at an acute angle.
